(19) United States
(12) Patent Application Publication
(10) Pub. No.: US 2020/0015521 A1
(43) Pub. Date: Jan. 16, 2020

(54) SIDE ACTUATED PERSONAL VAPORIZER CIGARETTE AND ASSOCIATED "MOD" DEVICE

(71) Applicant: FAST EDDIE'S VAPE SHOP AND LOUNGE, LLC, Orlando, FL (US)

(72) Inventor: Matthew R. Kleizo, Longwood, FL (US)

(21) Appl. No.: 16/034,676

(22) Filed: Jul. 13, 2018

(51) Int. Cl. A24F 47/00; H05B 3/44

(52) U.S. Cl. CPC A24F 47/008; H05B 2203/021; H05B 3/44

(57) ABSTRACT

A personal vaporizer device includes a metallic tube member having a substantially planar upper end configured to receive in an orifice a rebuildable atomizer deck and its atomizer pin that engages a first contact of a battery in the tube member. A paddle bar contact is at an outer surface of the tube member. A metallic battery contact cup is received within the tube open end and receives an end of the battery and engages the second terminal battery contact. An insulator sleeve is between the battery contact cup and the paddle bar contact and includes an opening that when aligned with the paddle bar contact, exposes the battery contact cup to the paddle bar contact. Depressing the paddle bar contact engages the paddle bar contact with the battery contact cup and completes an electrical circuit.

### FIELD OF THE INVENTION

This invention relates to electronic cigarettes formed as personal vaporizers, and more particularly, this invention relates to an electronic cigarette as a side actuated personal vaporizer and an associated “mod” device that supports a rebuildable atomizer, such as a rebuildable dripping atomizer (RDA).

### BACKGROUND OF THE INVENTION

Electronic cigarettes as personal vaporizers, also known as e-cigarettes or “vape” devices or inhalers, have become very popular in the last few years. Many of these devices operate as a battery-powered vaporizer that includes a mouth piece, a rebuildable atomizer often referred to as a deck, a juice or e-liquid that is vaporized, and a heating element or similar atomizer device. The heating element is typically at least one heating coil, which heats and vaporizes the juice. A wicking material helps draw the juice or e-liquid onto the coil such as from a well that holds the juice. In many devices, the user triggers device operation by “firing” or electrically actuating the heating coils via a switch on the side or end of the device to move a contact or “firing pin” into a terminal contact of a battery contained within the device housing to complete the circuit between the battery and the atomizer and energize the coils. This “firing pin” is often an electrical contact pin located on the bottom section of the housing that moves upward and engages the negative pole of the battery contained in the housing. A contact or atomizer pin extends downward from the rebuildable atomizer and engages the positive pole of the battery.

The designs of these personal vaporizer cigarette devices in use vary in size, configuration, style, and function. Recent design modifications include mechanical “mods,” for example, that are devices that do not contain electrical and electronic circuitry such as a microprocessor. Instead, the mechanical “mod” device has a “firing” button that is pressed, which physically makes a connection between the battery and the atomizer coil, thus, causing the coil to energize and heat up. These rebuildable atomizer decks allow a user to assemble or “build” the wick and coil themselves, instead of using off-the-shelf atomizer “heads.” One type of rebuildable atomizer is a rebuildable dripping atomizer (RDA), sometimes referred to as a “dripper.” Experienced users of these devices enjoy building their atomizers because they can choose a specific configuration and electrical resistance of their coil and also pick their flavor and the amount of aerosolized vapor produced by the device. In a rebuildable dripping atomizer, the juice is usually dripped directly onto the coil and the wick. The liquid or juice used in these devices generally has vegetable glycerin or propylene glycol and may include flavoring. The “building deck” or “deck” of a rebuildable atomizer such as an RDA usually has two or three or more posts with holes formed in them that accept one or more coils. The user typically drips the juice or e-liquid onto the bare wick and coil. In some devices, juice is drawn from a well. Often a well-built RDA will last as many as 10 to 20 puffs and emit very large quantities of vapor.

There are many different types and manufacturers of rebuildable atomizers. One common design aspect to many of these devices is that they include a similar connector as part of their rebuildable atomizer deck for attachment to the mod device. An example is a common “510” connector or atomizer pin that permits rebuildable atomizers of different types and manufacturers to be received on the personal vaporizer mod device, which is usually the tube or housing that holds the battery with its switch or firing mechanism located at the bottom of the tube. The rebuildable atomizer is usually attached via the atomizer “510” connector pin. The term “510” comes from the length of the connector and amount of threads it has to make a connection. It is typically 5 mm long and has 5 threads on the male connector part, such as the atomizer pin, and 5 threads on the female connector part, such as a threaded orifice of the mod device. Different personal vaporizer mod devices can be designed and receive different rebuildable atomizers via the threaded atomizer “510” atomizer pin as a standard connection. Of course, other connectors could be used, but the “510” connection is preferred. Many of these mod devices have their switch at the lower end of the tube or housing holding the battery. When the switch is closed, such as a user actuating from the bottom using their pinky, it completes the electrical circuit from the battery into the tube and into the rebuildable atomizer deck.

Some mod devices incorporate complicated switch designs that are unwieldy. Other mod devices are inefficient and do not provide for adequate venting of the battery or provide a mod that “hits” softly and does not give the user a hard, fast hit because of poor battery contact, switch design, and/or other issues. One problem associated with some mod devices is inadequate battery power transfer since separate electrical connectors may be required in addition to an inadequate housing design that holds the battery and inefficient switch design.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

A personal vaporizer mod device comprises a cylindrical housing comprising a tube member formed of a metallic material and having a first closed end and opposing open end and an outer surface. The first closed end of the tube member has a substantially planar upper end and a medially located orifice configured to receive an atomizer pin of a rebuildable atomizer deck that is supported on the planar upper end of the tube member such that the atomizer pin engages a first terminal contact of a battery received within the tube member. A paddle bar contact is formed within the outer surface of the tube member. A battery contact cup is formed of a metallic material and received within the open end of the tube member and configured to receive an end of a battery held within the tube member and engage a second battery contact opposite the first battery contact. An insulator sleeve is received within the tube member and positioned between the battery contact cup and the paddle bar contact, the insulator sleeve being rotatable within the tube member and having an opening that when aligned with the paddle bar contact, exposes the battery contact cup to the paddle bar contact such that depressing the paddle bar contact engages the paddle bar contact with the battery contact cup and completes an electrical circuit from the battery into the tube member and into the rebuildable atomizer deck.

In an example, the tube member may have a cutout within the outer surface and forming the paddle bar contact, and the cutout may comprise a U-shaped cutout. The first terminal contact of a battery may comprise a positive terminal that engages an atomizer pin of a rebuildable atomizer deck and the second terminal contact of the battery may comprise a negative terminal. The insulator sleeve may comprise a cup member formed of an insulator material and received over the battery contact cup and having a cutout forming the opening to expose the battery contact cup to the paddle bar contact.

In yet another example, a knob is located at the end of the tube member and connected to the insulator sleeve and configured to be grasped by a user and rotated to align the opening in the insulator sleeve with the paddle bar contact. A bottom housing member may be received within the open end of the tube member. The bottom housing member may engage the insulator sleeve and exert an upward axial force on the battery contact cup to force a battery contained within the tube member upward such that the first terminal contact of the battery engages an atomizer pin of a rebuildable atomizer deck received on the tube member. The open end of the tube member may include internal threads and the bottom housing member includes outer threads that engage the internal threads to allow axial movement of the bottom housing relative to the tube member upon rotation of the bottom housing member and adjust the upward axial force on the battery contact cup. The outer surface of the tube member may include a slot that exposes the insulator sleeve to permit a user to grasp and rotate the insulator sleeve and align the opening therein with paddle bar contact. A bar member may be attached to the paddle bar contact and form a user switch member that a user depresses to engage the paddle bar member with the battery contact cup.

In yet another example, a personal vaporizer mod may comprise a cylindrical housing comprising a tube member formed of a metallic material and having a first closed end and opposing open end and an outer surface having a cutout that is configured to form a paddle bar contact within the outer surface. The first closed end of the tube member may have a substantially planar upper end and a medially located orifice configured to receive an atomizer pin of a rebuildable atomizer deck that is supported on the planar upper end of the tube member such that the atomizer pin engages a first terminal contact of a battery received within the tube member.

A battery contact cup may be formed of a metallic material and received within the open end of the tube member and configured to receive an end of a battery held within the tube member and engage a second battery contact opposite the first battery contact. An insulator sleeve may be received within the tube member and positioned between the battery contact cup and the paddle bar contact. The insulator sleeve may comprise a cup member formed of an insulator material and received over the battery contact cup and being rotatable within the tube member and having cutout forming an opening that when aligned with the paddle bar contact, exposes the battery contact cup to the paddle bar contact such that depressing the paddle bar contact engages the paddle bar contact with the battery contact cup and completes an electrical circuit from the battery into the tube member and into the rebuildable atomizer deck. A bottom housing member may be received within the open end of the tube member. The bottom housing member may engage the insulator sleeve and exerts an upward axial force on the battery contact cup to force a battery contained within the tube member upward such that the first terminal contact of the battery engages the atomizer pin of a rebuildable atomizer deck received on the tube member. A knob may be carried by the bottom housing member and connected to the insulator sleeve and configured to be grasped by a user and rotated to align the opening in the insulator sleeve with the paddle bar contact.

In yet still another example, a personal vaporizer cigarette device may comprise a cylindrical housing comprising a tube member formed of a metallic material and having a first closed end and opposing open end and an outer surface having a cutout that is configured to form a paddle bar contact within the outer surface. The first closed end of the tube member has a substantially planar upper end and a medially located orifice. A rebuildable dripping atomizer (RDA) deck formed of a conductive material is supported on the substantially planar upper end of the tube member and having an atomizer pin that extends through the medially located orifice of the tube member and configured to engage a first terminal contact of a battery received within the tube member.

A battery contact cup formed of a metallic material is received within the open end of the tube member and configured to receive an end of the battery held within the tube member and engage a second battery contact opposite the first battery contact. An insulator sleeve is received within the tube member and positioned between the battery contact cup and the paddle bar contact. The insulator sleeve may comprise a cup member formed of an insulator material and received over the battery contact cup and being rotatable within the tube member and having cutout forming an opening that when aligned with the paddle bar contact, exposes the battery contact cup to the paddle bar contact such that depressing the paddle bar contact engages the paddle bar contact with the battery contact cup and completes an electrical circuit from the battery into the tube member and into the rebuildable atomizer deck. A bottom housing member is received within the open end of the tube member. The bottom housing member engages the insulator sleeve and exerts an upward axial force on the battery contact cup to force a battery contained within the tube member upward such that the first terminal contact of the battery engages the atomizer pin of the RDA deck received on the tube member. A knob is carried by the bottom housing member and connected to the insulator sleeve and configured to be grasped by a user and rotated to align the opening in the insulator sleeve with the paddle bar contact.

### DESCRIPTION OF THE DRAWINGS

Other objects, features and advantages of the present invention will become apparent from the detailed description of the invention, which follows when considered in light of the accompanying drawings in which:

FIG. 1 a perspective view of the personal vaporizer mod device looking in the direction of the first closed end that receives an atomizer pin of a rebuildable atomizer deck.

FIG. 2 is another perspective view of the personal vaporizer mod device looking in the direction of the bottom housing member.

FIG. 3 is an exploded isometric view of the personal vaporizer mod device showing the housing, bottom housing assembly, and battery adapter, and including the rebuildable atomizer that is received on the housing and a mouthpiece.

FIG. 4 is another isometric view of the personal vaporizer mod device similar to that shown in FIG. 1 and showing in detail the paddle bar contact.

FIG. 5 is an exploded isometric view of the personal vaporizer mod device shown in FIG. 2.

FIG. 6 is an enlarged sectional view of the lower end of the personal vaporizer mod device of FIG. 2 but without a battery.

FIG. 7 is a sectional view of the personal vaporizer mod device of FIG. 2 and showing the battery contained within the housing.

FIG. 8 is a partial sectional and isometric view of the personal vaporizer mod device of FIG. 2 showing the knob turned such that the opening in the insulator sleeve is not aligned with the paddle bar contact.

FIG. 9 is a partial sectional and isometric view of the personal vaporizer mod device similar to that shown in FIG. 8, but showing the knob turned such that the opening of the insulator sleeve is aligned with the paddle bar contact.

FIG. 10 is enlarged partial sectional and isometric view of the paddle bar contact, battery contact cup, and insulator sleeve shown in FIG. 9.

FIG. 11 is an isometric view of a second embodiment of the personal vaporizer mod device showing a slot in the outer surface of the housing that exposes an insulator sleeve as a ring member to permit a user to grasp and rotate the ring member.

FIG. 12 is a sectional view of the personal vaporizer mod device of FIG. 11.

FIG. 13 is an isometric view of the ring member of FIGS. 11 and 12.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

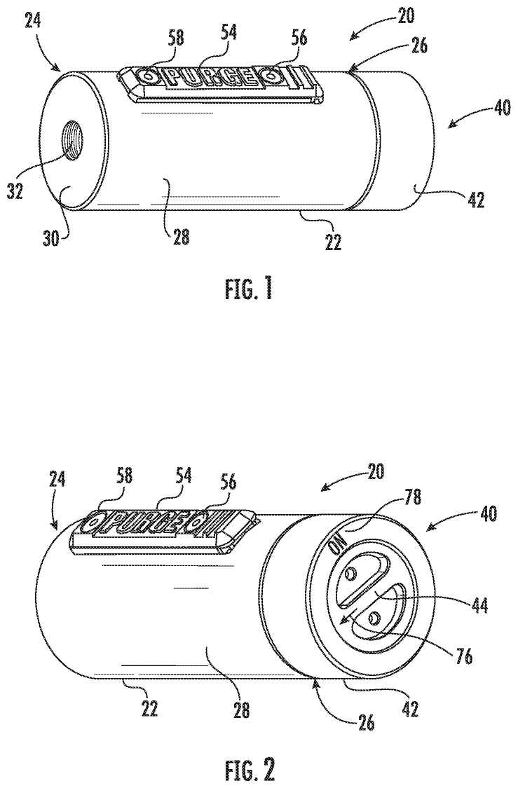

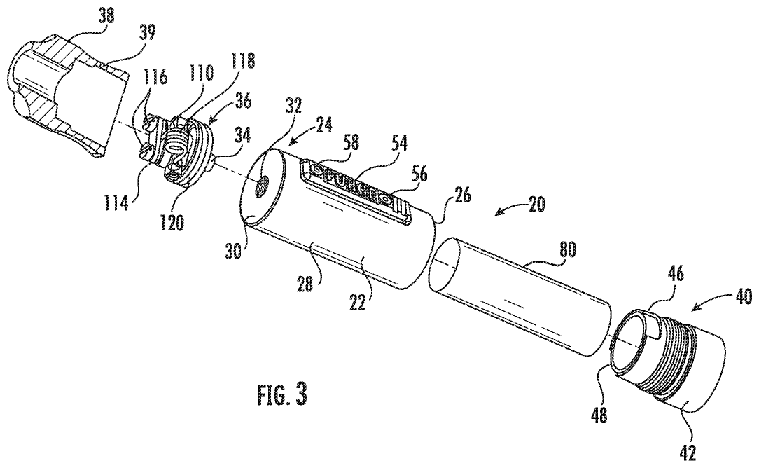

Referring now to FIGS. 1 and 2, there is illustrated at 20 a personal vaporizer mod device that includes a cylindrical housing 22 as a tube member formed of a metallic material, such as stainless steel, copper, brass, aluminum, or other metallic and/or conductive material, and having a closed end 24 at the housing's first or upper end and an opposing open end 26 as a second or lower end, and an outer surface 28. The first, closed end 24 of the tube member or housing 22 has a substantially planar and cylindrical upper end 30 (FIG. 1) and a medially located orifice 32 that is configured to receive an atomizer pin 34 such as a “510” connector of a rebuildable atomizer deck 36 that is supported on the planar upper end of the tube member as the housing 22 (FIG. 3). When the rebuildable atomizer deck 36 is supported at the planar upper end 30, the atomizer pin 34 is typically threaded into the threaded orifice 32 and the atomizer pin engages a first terminal contact as a positive connection of a battery received within the tube member 22. The second or lower end 26 corresponding to the open end of the tube member 22 receives a bottom housing assembly 40 that includes a bottom housing member 42 and a knob 44 that may be rotated to align an opening 46 in an insulated sleeve to expose a metallic battery contact cup 48 (FIGS. 5, 8 and 9) holding the battery and engaging the negative terminal of the battery with a paddle bar contact 50, so that upon a user is depressing the paddle bar contact, the user energizes or “fires” the device by completing an electrical circuit from the battery contained in the tube member as the housing 22 and into the rebuildable atomizer deck 36 when attached to the housing.

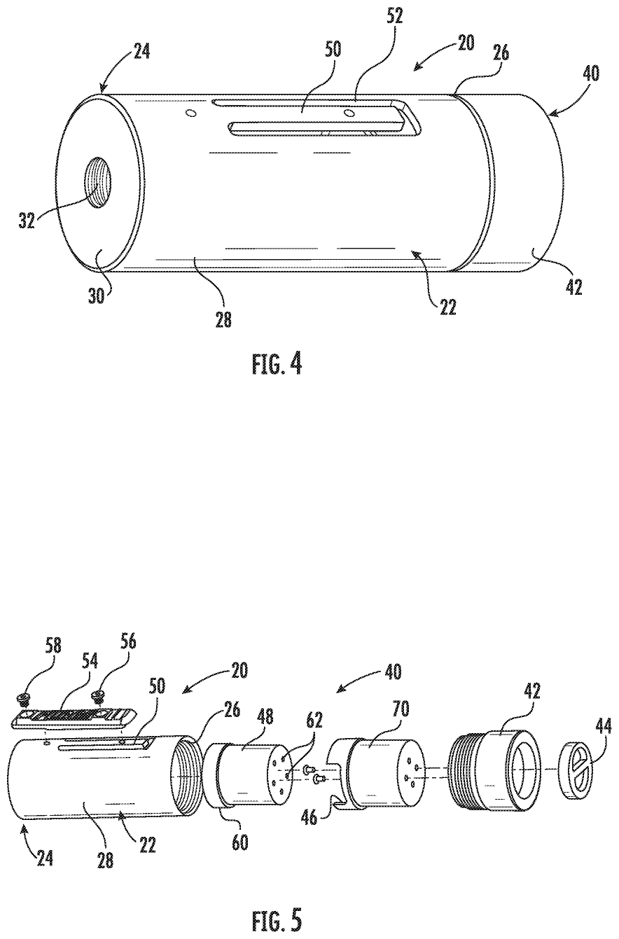

The paddle bar contact 50 is formed within the outer surface 28 of the tube member 22 (FIG. 4). In the example as illustrated, the tube member 22 has a cutout 52 within its outer surface 28 and forms the paddle bar contact 50. The cutout 52 in this example is formed as a U-shaped cutout, such that the open end of the “U” extends toward the first or upper closed end 24 of the tube member 22. The formed extension as the closed end of the paddle bar contact 50 extends toward the second or lower open end 26 such that the paddle bar contact may be depressed near the second or lower end of the tube member and engage the battery contact cup 48 when the opening 46 is aligned with the paddle bar contact. It should be understood that it is possible to have the paddle bar contact 50 that engages the battery contact cup 48 without an intervening insulator sleeve as a safety device such that simply depressing the paddle bar contact will make contact and “trigger” or close the circuit.

A bar member 54 is attached to the paddle bar contact 50 by a first screw 56 securing one end of the bar member at the end of the paddle bar contact that is depressed downward and by a second screw 58 to the other end of the bar member and onto the outer surface 28 of the tube member 22. Although screws are illustrated as a preferred fastening technique to facilitate easy removal of the bar member 54, other attachment techniques may be used. The bar member 54 may have decorative features such as a logo engraved 46 or formed thereon as illustrated in FIGS. 1-3 and operate as a user switch member that a user depresses to engage the paddle bar contact 50 with the battery contact cup 48 as shown in greater detail in FIG. 5. Because the bar member 54 is readily removable, different bar members 54 having different logos or designs may be secured, such as identifying indicia, trademarks, logos, or decorative designs.

As illustrated in FIGS. 5-7, the battery contact cup 48 is configured similar to a conventional cup and includes an upper circumferential ridge 60 or collar. The battery contact cup 48 is received within the open end 26 of the tube member as the housing 22 and configured to receive the end of a battery 64 (FIG. 7) contained within the tube member and engage the second battery terminal contact as the negative terminal in this example opposite the first battery terminal contact as the positive terminal that engages the atomizer pin 34. The battery contact cup 48 includes vent holes 62 to vent gas that may be discharged from the battery. An insulator sleeve 70 (FIG. 5) is received over the battery contact cup 48, and in a preferred example, is also configured as a cup member similar in configuration to that of the battery contact cup, but slightly larger in diameter to receive the battery contact cup. This insulator sleeve 70 also includes an upper circumferential ridge 72 or collar and includes the opening 46 as a notch in the upper circumferential ridge that aligns with the paddle bar contact 50 when the insulator sleeve is rotated to align the opening and paddle bar contact.

The insulator sleeve 70 as a cup member is formed of an insulator material, such as a plastic material, and received over the battery contact cup 48 and has its opening 48 formed as a cutout or notch in the upper ridge 72 of the insulator sleeve, which can be rotated to align the opening 46 with the paddle bar contact 50, and thus, expose the metallic battery contact cup 48 to the metallic paddle bar contact formed from the tube member 22. The insulator sleeve 70 as a cup is received within the bottom housing member 42 as part of the bottom housing assembly 40. The knob 44, battery contact cup 48, and insulator sleeve 70 are received within the bottom housing member 42, which all form the bottom housing assembly 40. The bottom housing member 42 includes outer threads to allow the bottom housing member to be threaded or screwed into the lower end 26 of the tube member 22, which includes internal threads. The bottom housing member 42 includes an open lower end that receives the knob 44 for rotation therein. Screws 74 attach the knob 44 to the insulator sleeve 70, and more particularly, the bottom wall section of the cup configuration. When the knob 44 is rotated 90 degrees, the insulator sleeve 70, in turn, is rotated relative to the battery contact cup 48 and aligns the notch or opening 46 with the paddle bar contact 50 such that a user may depress the paddle bar contact and engage the paddle bar contact with the battery contact cup, thus completing an electrical circuit from the battery 64 shown in FIG. 7 into the tube member 22 and into the rebuildable atomizer deck 36 shown in FIG. 3.

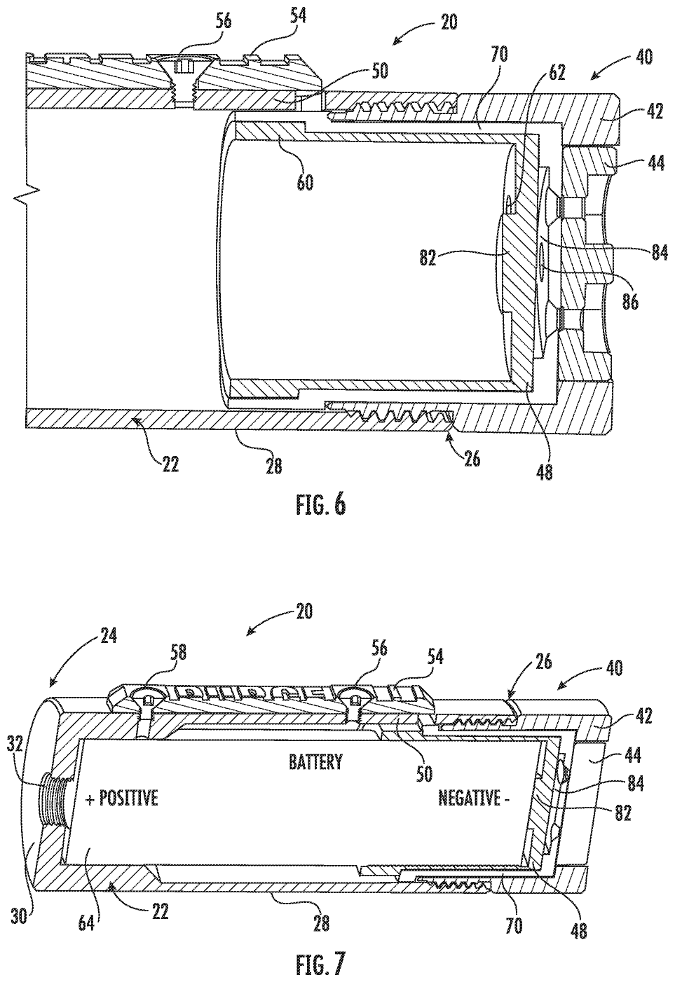

The battery contact cup 48 is received within the insulator sleeve 70 formed as a similarly configured but slightly larger cup member as compared to the battery contact cup. The insulator sleeve 70 is received within the bottom housing member 42 and secured to the knob 44 by the screws 74. The bottom housing member 42 is threaded or screwed into the lower or second open end 26 of the tube member (FIG. 6). The knob 44 is configured to be grasped by a user and rotated to align the opening 46 in the insulator sleeve 70 with the paddle bar contact 50. The knob 44 may include a marking or indicia 76 on its outer surface that align with a marking or indicia 78 on the bottom housing member 42 on its lower exposed end such that when the indicia 76, 78 are aligned together, their alignment may indicate when the opening 46 in the insulator sleeve 70 is aligned with the paddle bar contact 50. For example, as shown in FIGS. 2, 8, and 9, the knob 44 may include an arrow that points to the words on or off or similar language or other indicia indicating that the opening is aligned with the paddle bar contact such that it can be depressed to activate and complete the electrical circuit.

The bottom housing member 42 receives the insulator sleeve 70 and battery contact cup 48 and together with the knob 44 form the bottom housing assembly 40. When the bottom housing member 42 is screwed within the lower open end 26 of the tube member as the housing 22, it exerts an upward axial force on the insulator sleeve 70, the battery contact cup 48 and the battery 64 contained therein. The battery 64 is received within the insulator sleeve such as being held within a cup such that the first terminal contact of the battery would be biased upward as the bottom housing member is threaded and moved upward axially so that the battery positive terminal engages the atomizer pin 34 of the rebuildable atomizer deck 36 that is received on the planar upper end 30 of the tube member as the housing 22. The rebuildable atomizer deck 36, in an example, is formed as a rebuildable dripping atomizer (RDA) and its atomizer pin 34 is screwed into the medially located orifice 32. The bottom housing member 42 may be threaded or screwed a predetermined number of times to adjust its axial positioning and ensure a tight engagement of the battery 64 within the battery contact cup 48 and against the atomizer pin 34 and also prevent battery “rattle.” The bottom housing member 42 with its outer threads engage the internal threads on the open end 26 of the tube member as the housing and permits axial movement of the bottom housing member 42 relative to tube member upon rotation of the bottom housing member, and thus, adjust the upward axial force on the battery contact cup and help accommodate different battery sizes. For example, the length of the battery may vary slightly and adjustments can be made to ensure a good contact of the battery with the atomizer pin and also prevent battery rattle. It may also help accommodate the use of a battery adapter 80 or sleeve such as shown in FIG. 3.

Referring now to FIGS. 6 and 7, there are shown greater details of the battery contact cup 48 received within the insulator sleeve 70 as a cup member, which are both received within the bottom housing member 42 with the knob 44 attached to the insulator sleeve. The battery contact cup 48 includes a battery pedestal support 82 or contact that engages the negative terminal of a battery received within the housing 22 and contained at the battery lower end within the battery contact cup 48. The insulator sleeve 70 as a cup member includes a circular slot or a partial circular cutout 84 on the bottom interior surface that forms the bottom or floor of the cup so that the screws 74 that secure the knob 44 to the insulator sleeve 70 would not engage the lower end of the battery contact cup 48. The cutout 84 also provides an air gap between the outside lower bottom or floor of the battery contact cup and the insulator sleeve to help vent battery gas through the vent hole 62, which in turn, can be vented out of the bottom housing member 42 via other vent holes 86.

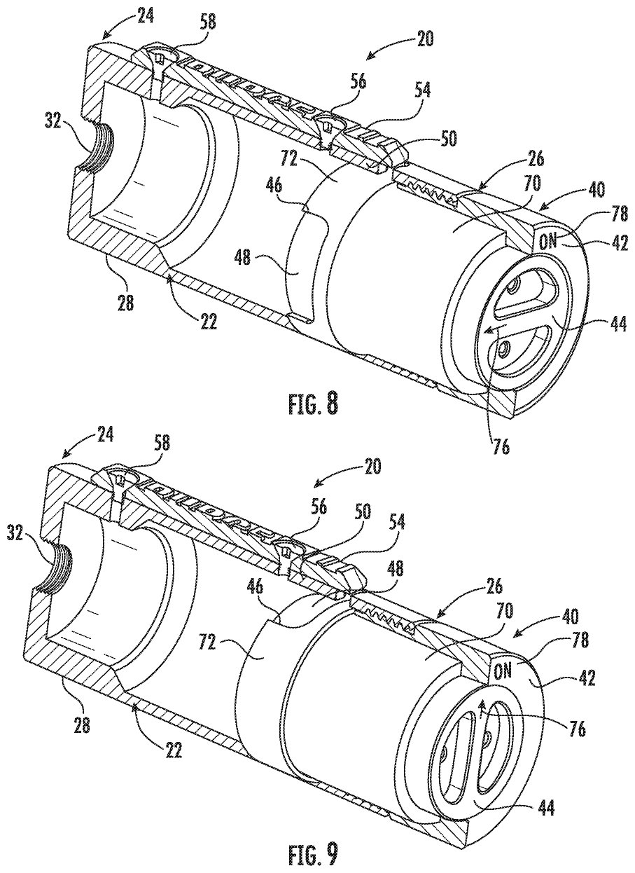

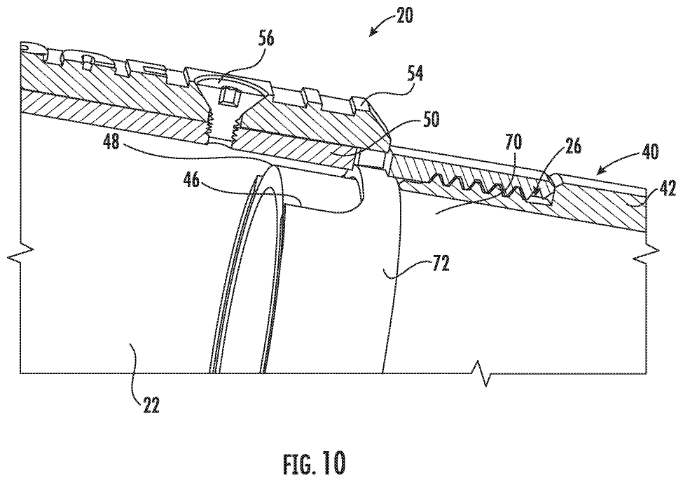

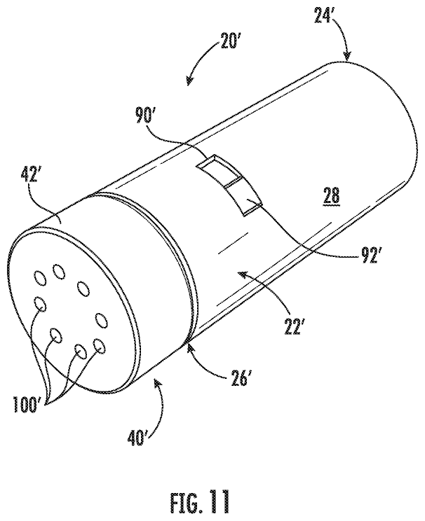

Referring now to FIGS. 8-10, there are shown greater details of how the knob 44 may be rotated about 90° from the inactive position shown in FIG. 8 to an active or firing position shown in FIG. 9 to align the cutout forming the opening 46 with the paddle bar contact 50 to expose the battery contact cup 48 to the paddle bar contact 50 such that the user's depressing the paddle bar contact engages the paddle bar contact with the battery contact cup and completes an electrical circuit from the battery 64 into the tube member 22 and into the rebuildable atomizer deck 36. In FIG. 8, the knob 44 is in a safety position such that the opening 46 in the insulator sleeve 70 is not aligned with the paddle bar contact 50, which when depressed, will instead engage the closed section of the insulator sleeve and not engage the battery contact cup 48. When the knob is rotated 90° as shown in FIGS. 9 and 10, the notch or opening 46 in the insulator sleeve 70 is aligned with the paddle bar contact 50, which when depressed, is free to pass through the notch or opening and engage the battery contact cup 48 and complete the circuit.

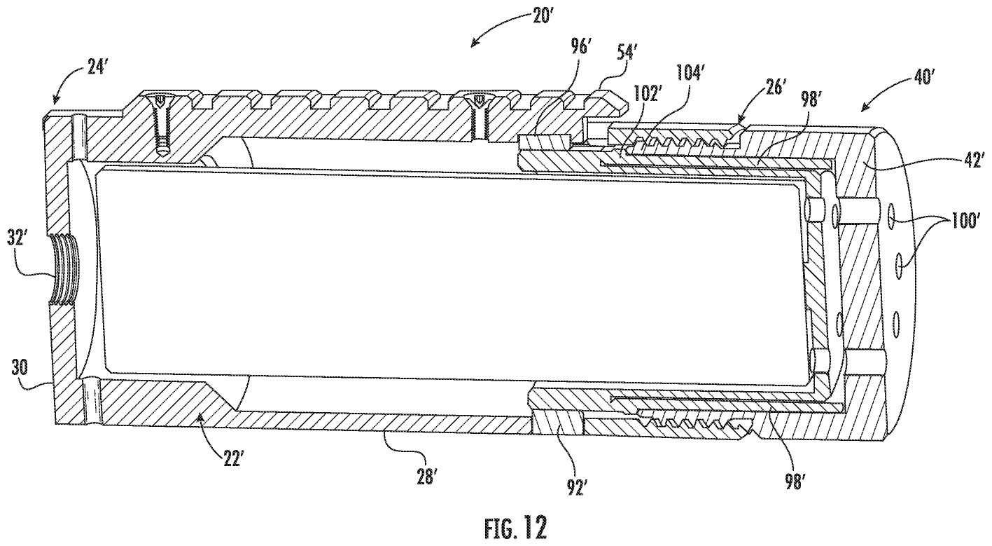

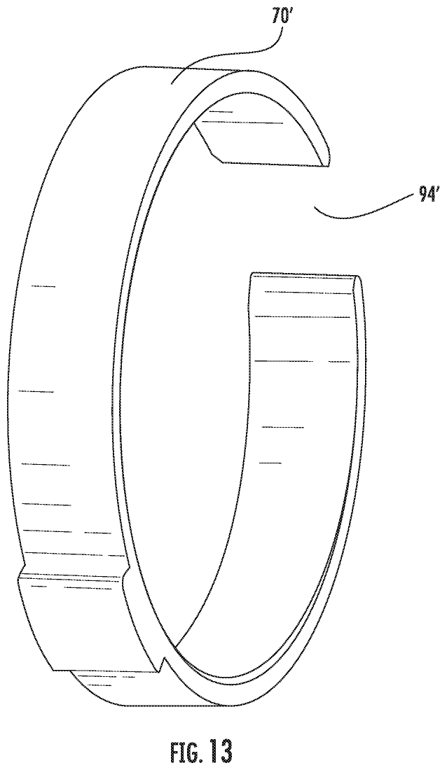

Referring now to FIGS. 11-13, there is illustrated a different embodiment of the personal vaporizer mod device 20′ where reference numerals are given prime notation. In this example, the outer surface 28′ of the tube member 22′ includes a slot 90′ (FIG. 11) that exposes the insulator sleeve 70′ formed as a ring member (FIG. 13), which permits a user to grasp an extension 92′ on the ring member, i.e., the insulator sleeve 70′, and rotate it slightly to align an opening 94′ formed within the ring member with the paddle bar contact 50′ so that the paddle bar contact can be depressed and engage the battery contact cup 48′. In this example, the ring member configured as the insulator sleeve 70′ slides within an annular groove or slot 96′ formed within the interior surface of the tube member 22′ as best shown in FIG. 12, so that the insulator sleeve 70′ as a ring member may be rotated slightly a few degrees and align its opening 94′ with the paddle bar contact 50′.

The battery contact cup 48′ is configured similar to the battery contact cup shown in FIG. 5 with its circumferential upper ridge 60′ at the upper end of the battery contact cup. Instead of the insulator sleeve 70′ configured as a cup member as in the first embodiment such as shown in FIG. 5, and receiving the battery contact cup 48′, a separate annular or cylindrical sleeve 98′ is formed as an open ended cylinder and positioned between the lower end 26′ of the tube member 22′ and the bottom housing member 42′, which in the illustrated embodiment of FIG. 12, does not include a knob, but instead includes additional vent holes 100′. A gap exists between the lower end of the battery contact cup 48′ and the bottom housing member 42′ to help vent battery gas. The annular or cylindrical sleeve 98′ has a top shoulder 102′ that engages an upper circumferential ridge 104′ of the bottom housing member 42′ and catches the lower end of the upper circumferential ridge or collar 60′ of the battery contact cup 48′ at a location to prevent the lower end of the battery contact cup from engaging the bottom housing member 42′ while leaving an air space for battery gas venting and other purposes.

Referring again to FIG. 3, there is illustrated an exploded isometric view of the cylindrical housing 22 that receives the rebuildable atomizer 36 via a 510 connector and includes the atomizer pin 34, which in a non-limiting example is described in greater detail in copending and commonly assigned U.S. patent application Ser. No. 15/921,926 filed on Mar. 15, 2018; and U.S. patent application Ser. No. 16/029,730 filed on Jul. 9, 2018, by the same inventor, the disclosures which are hereby incorporated by reference in their entirety.

The rebuildable atomizer deck 36 is illustrated as a rebuildable dripping atomizer (RDA). When rebuilding RDA decks, there is usually a positive post in the center and one or more negative posts located outside the center. One end or lead of a coil is attached to the positive post, and the other lead or coil is attached to one of the negative posts. This process is repeated on opposing sides when two coils are used. In some devices, air flow control is maintained by spinning the top piece as the mouthpiece 38 to close off any air holes 39 or open them wide. The number of air holes 39 can vary so that the atomizer is used efficiently with one or two or more coils and the holes may be lined up adjacent to coils. When a single coil is used, the atomizer or RDA operates in a single coil mode, but with two coils, the atomizer or RDA operates in a dual coil mode.

Building the coils typically requires a user to select the type of wire and its gauge. In one example, the user wraps the wire around a cylindrical object to form the coil and then inserts the coil within the negative or positive leads in order to make a “build.” Often the device configuration does not permit an efficient electrical connection and makes the build difficult and some designs are clumsy to use after the build.

The copending and incorporated by reference '926 and '730 applications disclose a hybrid sleeve as part of a female tube member formed of a metallic material as part of a personal vaporizer mod device where a male tube member is inserted and receives a battery. A switch is part of a button housing and includes a button member on its lower end. In the design as illustrated in the copending applications, the rebuildable atomizer deck 36 is formed as an RDA subassembly, such as shown in FIG. 3 of the current application, and includes the cylindrically configured RDA deck 36 formed from a conductive materials such as stainless steel, brass, copper, or other metallic material and supported at the planar upper end 30 of the housing 22. The RDA deck 36 supports first and second heating cools with each being a single large filament as a heating coil or a number of individual filaments wound together. The RDA deck includes a central orifice and first and second spaced terminal posts configured to connect the first ends of respective first and second heating coils using a mechanical attachment mechanism.

A T-column as a central column terminal includes a central post received within a central orifice of the RDA deck and engages a positive pole battery held within the housing and in this case by a battery sleeve or adapter. A transverse support 110 is formed as an upper “T” of the “T-column” and carried by the central post and spaced above the terminal posts and on which second ends of respective first and second heating coils are positioned. The ends are positioned on a compression slot formed thereon.

As described in further detail in the above-identified and incorporated by reference copending '926 and '730 patent applications, a clamp 114 is secured on the transverse support and fixes the second ends of the heating coils on the transverse support 110 and secured by screws 116. An insulator may be formed as a sleeve and received within the central orifice of the RDA deck and receives a central post that separates and electrically insulates the central post from the RDA deck. It may be formed from a plastic or other insulator material. The RDA deck may include a cylindrically configured and recessed well below the terminal posts to hold the juice for vaping, for example. The terminal post may be formed on an upper circumferential edge of the RDA deck so that the well has a large annular configuration that is deep, and in an example, has an internal step configuration.

In operation, when a user depresses the paddle bar contact 50 and it engages the battery contact cup 48 because the opening or notch 46 is aligned as a safety feature, the electrical circuit is completed from the negative pole of the battery at the lower end of the housing and through the housing to the RDA deck 36 and energizes the heating coils to vaporizer the juice contained on at least one wick, and in the illustrated example, wicks held by heating coils 118. The central post includes the contact screw as part of the atomizer pin 34 that engages the battery, such as the positive terminal at the top of the battery, and could be adjustable relative to the battery to ensure electrical contact. This contact screw may be insulated from the RDA deck 36 by an appropriate insulator material formed such as a sleeve ring. Different set screws may secure the ends of the heating coils onto the respective terminal posts and clamp screws may secure the clamp bar to the transverse support.

As illustrated, the RDA deck 36 includes an annular outer surface and supports at least one O-ring 120 on the outer surface to retain the RDA cap as a mouthpiece 38, and also termed drip tip, over the RDA deck or other rebuildable atomizer deck 36 as may be attached to this side actuated personal vaporizer mod device 20. The heating coils are sometimes referred to as wire filaments by some skilled in the art since the heating coils are small gauge wires. A heating coil may also be formed from a plurality of wire filaments that are wound together. Typically, a heating coil is one gauge and a small diameter of wire or filament that is formed of a material having properties that allow it to heat and vaporizer the juice when a current flows through the wire. The at least one O-ring 120 may be formed from an easily compressible and elastic material and served to create an air-tight seal between the RDA cap and drip tip as the mouthpiece 38, which is commonly used in the art and operate as an assembly technique via a compression fit interaction.

The atomizer pin 34 may include a contact screw also termed by some as a 510 pin and is also made from an electrically conductive material and could be formed by one or more components along with the other conductive components, to transmit electrical energy from the positive battery terminal to the heating coils. The contact screw may be inserted into a through-hole of a sleeve ring and the combination of the two then inserted into the through-hole as the central orifice of the RDA deck from below and then further assembled by mechanical attachment to the central post and sleeve. The contact screw may serve as one of the two electrical contacts for the battery and maintain a constant electrical connection with the battery when the device is fully assembled.

The clamp screws 116 may also be made from an electrically conductive material to affix the clamp bar to the transverse support 110 as the top “T” of the central column terminal, also termed the T-column, via a mechanical attachment using clamp screws in the preferred embodiment to apply compressive forces between the clamp bar and the central column terminal such that force is applied to the ends of the heating coils 118 and thereby retain and affix free ends of the wire filament or heating coil in place. This creates an electrical connection between the central column terminal and a clamp bar and heating coils.

The heating coils 118 may be formed from multiple strands of wire filaments or one wire as a single gauge forming a heating coil as a single strand, and of course, from an electrically conductive material that has the properties and resistant to heat up when the switch is closed and atomize fluid on a wick. The physical connection is made at either free end to create an electrical connection where the electrical energy is passed to the heating coils 118 upon activation of the device as an electronic cigarette by the user.

The tube member forming the housing 22 may be made from an electrically conductive material and may receive a battery adapter 80 as a sleeve as shown in FIG. 3. The battery adapter 80 as a sleeve may accommodate various diameter battery sizes and the battery adapter may include a lower contact that engages the negative terminal of the battery. The battery adapter 80 may also be sized to accommodate different lengths of batteries, which can also be accommodated by the bottom housing member 42 that screws into the lower end 26 of the tube member 22 so that its length may be adjusted and press the battery upward.

The RDA deck 36 in this example may be about 22 mm and include 2.5 mm post holes to fit different and popular gauges of wire. It may include titanium screws and has an easy building area. The terminal posts can be milled to the deck to cut down on spinning or breaking. The positive center may have a keyed bottom to prevent spinning. The titanium screws may also add to the aesthetic appeal. An example battery may be added by unscrewing the bottom housing member 42 and inserting a battery. An example could be a high drain 40 amp battery with the positive end in first.

Different types of heating coils “vape wires” may be used, including Kanthal (FGe Cr Al), Nichrome, stainless steel, nickel, and titanium. Stainless steel is considered by many to be the most versatile. Different grades of stainless steel wire may be used. The most popular gauges for the wire are 32, 30, 28, 26, 24, and 22. The type of wicking material can vary and could include organic cotton, Japanese cotton pads, ekowool, silica, and rayon fiber.

The device as described is a personal vaporizer that operates as an inhaler for “vaping” and of course, for personal use. It may use the described RDA deck 36 as a subassembly as illustrated, which is connected by its threaded connector as the atomizer pin 34 into the threaded medially located orifice 32 of the tube member 32, which operates similar to the female tube member as described in the incorporated by reference '926 and '730 patent applications, and operates similar to a sleeve, in an example, to receive the bottom housing assembly 40. The tube member 22, bottom housing member 42, and battery contact cup 48 can be formed of a metallic material such as stainless steel, brass, copper, aluminum, or other metallic and/or conductive material, and could be formed from a metal plated plastic in an embodiment. It could be formed from other conductive material. In one example, the tube member as a housing 22 could be referred to as a hybrid sleeve since the tube member will receive the rebuildable atomizer deck 36 and the atomizer pin 34 via the 510 connection. It should be understood that different rebuildable atomizers (RBA's) may be supported by and connected to the tube member.

Referring again to FIG. 3, there are shown the battery adapter 80 or sleeve, which may be configured to receive a battery having a different size different than that normally used and contained in the housing, since the battery may not fit comfortably within the tube member. Different batteries can be accommodated by a particular sized battery adapter 80, such as sized for a 18650 battery. The battery adapter 80 may include a contact at the end with vent holes at the bottom typically. As noted before, the personal vaporizer mod device 20 may be compatible with 18650, 20700, and other battery sizes and be made adaptable for different size batteries not only by the use of different battery adapters 80, but also because the bottom housing member 42 can be secured at different axial lengths within the tube member 22. Ornamental effects may be placed onto the outer surface 28 of the tube member 22 and on the bar member 54. Artwork of different designs can be machined such as by CNC deep into the outer surface 28 of the tube member 22.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A personal vaporizer mod device, comprising:
a cylindrical housing comprising a tube member formed of a metallic material and having a first closed end and opposing open end and an outer surface, wherein the first closed end of the tube member has a substantially planar upper end and a medially located orifice configured to receive an atomizer pin of a rebuildable atomizer deck that is supported on the planar upper end of the tube member such that the atomizer pin engages a first terminal contact of a battery received within the tube member;
a paddle bar contact formed within the outer surface of the tube member;
a battery contact cup formed of a metallic material and received within the open end of the tube member and configured to receive an end of a battery held within the tube member and engage a second battery contact opposite the first battery contact; and
an insulator sleeve received within the tube member and positioned between the battery contact cup and the paddle bar contact, said insulator sleeve being rotatable within the tube member and having an opening that when aligned with the paddle bar contact, exposes the battery contact cup to the paddle bar contact such that depressing the paddle bar contact engages the paddle bar contact with the battery contact cup and completes an electrical circuit from the battery into the tube member and into the rebuildable atomizer deck.

2. The personal vaporizer mod device according to claim 1, wherein the tube member has a cutout within the outer surface and forming the paddle bar contact.

3. The personal vaporizer mod device according to claim 2, wherein the cutout comprises a U-shaped cutout.

4. The personal vaporizer mod device according to claim 1, wherein the first terminal contact of a battery comprises a positive terminal that engages an atomizer pin of a rebuildable atomizer deck and the second terminal contact of the battery comprises a negative terminal.

5. The personal vaporizer mod device according to claim 1, wherein the insulator sleeve comprises a cup member formed of an insulator material and received over the battery contact cup and having a cutout forming the opening to expose the battery contact cup to the paddle bar contact.

6. The personal vaporizer mod device according to claim 1, further comprising a knob located at the end of the tube member and connected to said insulator sleeve and configured to be grasped by a user and rotated to align the opening in the insulator sleeve with the paddle bar contact.

7. The personal vaporizer mod device according to claim 1, further comprising a bottom housing member received within the open end of the tube member, wherein the bottom housing member engages the insulator sleeve and exerts an upward axial force on the battery contact cup to force a battery contained within the tube member upward such that the first terminal contact of the battery engages an atomizer pin of a rebuildable atomizer deck received on the tube member.

8. The personal vaporizer mod device according to claim 7, wherein the open end of the tube member includes internal threads and said bottom housing member includes outer threads that engage the internal threads to allow axial movement of the bottom housing relative to the tube member upon rotation of the bottom housing member and adjust the upward axial force on the battery contact cup.

9. The personal vaporizer mod device according to claim 1, wherein the outer surface of the tube member includes a slot that exposes said insulator sleeve to permit a user to grasp and rotate the insulator sleeve and align the opening therein with paddle bar contact.

10. The personal vaporizer mod device according to claim 1, further comprising a bar member attached to the paddle bar contact and forming a user switch member that a user depresses to engage the paddle bar member with the battery contact cup.

11. A personal vaporizer mod device, comprising:
a cylindrical housing comprising a tube member formed of a metallic material and having a first closed end and opposing open end and an outer surface having a cutout that is configured to form a paddle bar contact within the outer surface, wherein the first closed end of the tube member has a substantially planar upper end and a medially located orifice configured to receive an atomizer pin of a rebuildable atomizer deck that is supported on the planar upper end of the tube member such that the atomizer pin engages a first terminal contact of a battery received within the tube member;
a battery contact cup formed of a metallic material and received within the open end of the tube member and configured to receive an end of a battery held within the tube member and engage a second battery contact opposite the first battery contact;
an insulator sleeve received within the tube member and positioned between the battery contact cup and the paddle bar contact, said insulator sleeve comprising a cup member formed of an insulator material and received over the battery contact cup and being rotatable within the tube member and having cutout forming an opening that when aligned with the paddle bar contact, exposes the battery contact cup to the paddle bar contact such that depressing the paddle bar contact engages the paddle bar contact with the battery contact cup and completes an electrical circuit from the battery into the tube member and into the rebuildable atomizer deck; and
a bottom housing member received within the open end of the tube member, wherein said bottom housing member engages the insulator sleeve and exerts an upward axial force on the battery contact cup to force a battery contained within the tube member upward such that the first terminal contact of the battery engages the atomizer pin of a rebuildable atomizer deck received on the tube member, and a knob carried by the bottom housing member and connected to said insulator sleeve and configured to be grasped by a user and rotated to align the opening in the insulator sleeve with the paddle bar contact.

12. The personal vaporizer mod device according to claim 11, wherein the cutout comprises a U-shaped cutout.

13. The personal vaporizer mod device according to claim 11, wherein the rebuildable atomizer deck comprises a rebuildable dripping atomizer.

14. The personal vaporizer mod device according to claim 11, wherein the first terminal contact of a battery comprises a positive terminal that engages an atomizer pin of a rebuildable atomizer deck and the second terminal contact of the battery comprises a negative terminal.

15. The personal vaporizer mod device according to claim 11, wherein the open end of the tube member includes internal threads and said bottom housing member includes outer threads that engage the internal threads to allow axial movement of the bottom housing relative to the tube member upon rotation of the bottom housing member and adjust the upward axial force on the battery contact cup.

16. The personal vaporizer mod device according to claim 11, further comprising a bar member attached to the paddle bar contact and forming a user switch member that a user depresses to engage the paddle bar member with the battery contact cup.

17. A personal vaporizer cigarette device, comprising:
a cylindrical housing comprising a tube member formed of a metallic material and having a first closed end and opposing open end and an outer surface having a cutout that is configured to form a paddle bar contact within the outer surface, wherein the first closed end of the tube member has a substantially planar upper end and a medially located orifice;
a rebuildable dripping atomizer (RDA) deck formed of a conductive material and supported on the substantially planar upper end of the tube member and having an atomizer pin that extends through the medially located orifice of the tube member and configured to engage a first terminal contact of a battery received within the tube member;
a battery contact cup formed of a metallic material and received within the open end of the tube member and configured to receive an end of the battery held within the tube member and engage a second battery contact opposite the first battery contact;
an insulator sleeve received within the tube member and positioned between the battery contact cup and the paddle bar contact, said insulator sleeve comprising a cup member formed of an insulator material and received over the battery contact cup and being rotatable within the tube member and having cutout forming an opening that when aligned with the paddle bar contact, exposes the battery contact cup to the paddle bar contact such that depressing the paddle bar contact engages the paddle bar contact with the battery contact cup and completes an electrical circuit from the battery into the tube member and into the rebuildable atomizer deck; and
a bottom housing member received within the open end of the tube member, wherein said bottom housing member engages the insulator sleeve and exerts an upward axial force on the battery contact cup to force a battery contained within the tube member upward such that the first terminal contact of the battery engages the atomizer pin of the RDA deck received on the tube member, and a knob carried by the bottom housing member and connected to said insulator sleeve and configured to be grasped by a user and rotated to align the opening in the insulator sleeve with the paddle bar contact.

18. The personal vaporizer cigarette device according to claim 17, wherein the cutout comprises a U-shaped cutout.

19. The personal vaporizer cigarette device according to claim 17, wherein the first terminal contact of a battery comprises a positive terminal that engages the atomizer pin of the RDA deck and the second terminal contact of the battery comprises a negative terminal.

20. The personal vaporizer cigarette device according to claim 17, wherein the open end of the tube member includes internal threads and said bottom housing member includes outer threads that engage the internal threads to allow axial movement of the bottom housing relative to the tube member upon rotation of the bottom housing member and adjust the upward axial force on the battery contact cup.

21. The personal vaporizer cigarette device according to claim 17, further comprising a bar member attached to the paddle bar contact and forming a user switch member that a user depresses to engage the paddle bar member with the battery contact cup.
